(19) United States
(12) Patent Application Publication
(10) Pub. No.: US 2025/0325033 A1
(43) Pub. Date: Oct. 23, 2025

(54) AEROSOL-GENERATING DEVICE

(71) Applicant: KT&G CORPORATION, Daejeon (KR)

(72) Inventors: Dongsung KIM, Seoul (KR); Youngbum KWON, Gyeonggi-do (KR); Yonghwan KIM, Gyeonggi-do (KR); Hwikyeong AN, Seoul (KR)

(73) Assignee: KT&G CORPORATION, Daejeon (KR)

(21) Appl. No.: 19/095,431

(22) Filed: Mar. 31, 2025

(30) Foreign Application Priority Data
Apr. 23, 2024 (KR) 10-2024-0053874

(51) Int. Cl. A24F 40/465; A24F 40/20; A24F 40/51; A24F 40/53; A24F 40/57; A24F 40/60; A24F 40/65

(52) U.S. Cl. CPC A24F 40/465; A24F 40/20; A24F 40/57; A24F 40/51; A24F 40/53; A24F 40/60; A24F 40/65

(57) ABSTRACT

An aerosol-generating device is disclosed. The aerosol-generating device includes a body, a hollow heater disposed in the body, providing an insertion space with one side open, and providing therein an electrically conductive track, a circuit board disposed in the body, and a lead disposed at one side of the heater and connecting the electrically conductive track to the circuit board. A temperature coefficient of resistance of the lead is 6 to 10 ppm/° C.

### CROSS-REFERENCE TO RELATED APPLICATIONS

Pursuant to 35 U.S.C. § 119(a), this application claims the benefit of earlier filing date and right of priority to Korean Patent Application No. 10-2024-0053874 filed on Apr. 23, 2024, the contents of which are all hereby incorporated by reference herein in their entireties.

### BACKGROUND OF THE DISCLOSURE

### 1. Field of the Disclosure

The present disclosure relates to an aerosol-generating device.

### 2. Description of the Related Art

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

In an aerosol-generating device using a resistance heater, if the temperature of the heater is detected through change in the resistance of the heater without a separate temperature sensor, change in the resistance of a lead for connecting the heater to a driving circuit acts as noise. If change in the resistance of the lead is large, the temperature of the heater may not be accurately measured. If the temperature of the heater is measured inaccurately, the heating temperature of the heater may not be accurately controlled. Accordingly, an atomization amount or flavor may vary, which leads to a reduction in user satisfaction.

### SUMMARY OF THE DISCLOSURE

It is an object of the present disclosure to solve the above and other problems.

It is another object of the present disclosure to provide an aerosol-generating device in which the temperature coefficient of resistance of a lead of a heater is much less than that of an electrically conductive track.

It is still another object of the present disclosure to provide an aerosol-generating device in which the resistance value of the lead of the heater is much less than that of the electrically conductive track.

It is still another object of the present disclosure to provide an aerosol-generating device in which a heat-generating track disposed at an outermost position among heat-generating tracks of the electrically conductive track is long and wide.

In accordance with an aspect of the present disclosure for accomplishing the above and other objects, there is provided an aerosol-generating device including a body, a hollow heater disposed in the body, providing an insertion space with one side open, and providing therein an electrically conductive track, a circuit board disposed in the body, and a lead disposed at one side of the heater and connecting the electrically conductive track to the circuit board, wherein a temperature coefficient of resistance of the lead is 6 to 10 ppm/° C.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF THE DRAWINGS

The above and other objects, features, and other advantages of the present disclosure will be more clearly understood from the following detailed description taken in conjunction with the accompanying drawings, in which:

FIGS. 1 and 2 are views showing an aerosol-generating device according to embodiments of the present disclosure;

FIG. 3 is a view showing a stick according to an embodiment of the present disclosure;

FIG. 4 is a front perspective view of a heater assembly according to an embodiment of the present disclosure;

FIG. 5 is an exploded perspective view of the heater assembly according to the embodiment of the present disclosure;

FIG. 6 is a view showing a susceptor of the heater assembly according to the embodiment of the present disclosure;

FIGS. 7 and 8 are views showing brackets of the heater assembly according to the embodiment of the present disclosure;

FIG. 9 is a view showing an electrically conductive track of the heater assembly according to the embodiment of the present disclosure;

FIG. 10 is an enlarged perspective view showing a portion of the electrically conductive track of the heater assembly according to the embodiment of the present disclosure;

FIG. 11 is a diagram illustrating a circuit for measurement of the resistance of a heater in the aerosol-generating device according to the embodiment of the present disclosure;

FIG. 12 is a graph illustrating change in resistance value depending on the temperature of the heater assembly according to the embodiment of the present disclosure;

FIG. 13 is a graph illustrating change in the ratio of the resistance value of a lead to the resistance value of the electrically conductive track depending on heating of the heater assembly according to the embodiment of the present disclosure; and

FIG. 14 is a block diagram of an aerosol-generating device according to an embodiment of the present disclosure.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Throughout the present specification, the directions of an aerosol-generating device 1 may be defined based on an orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

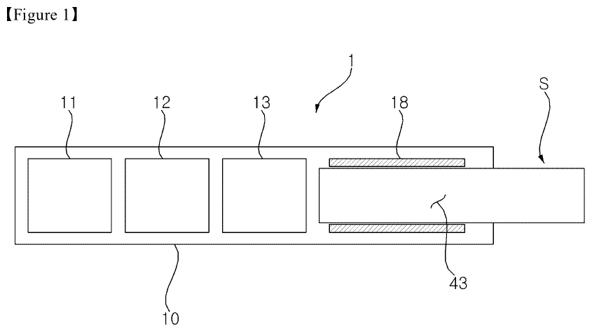

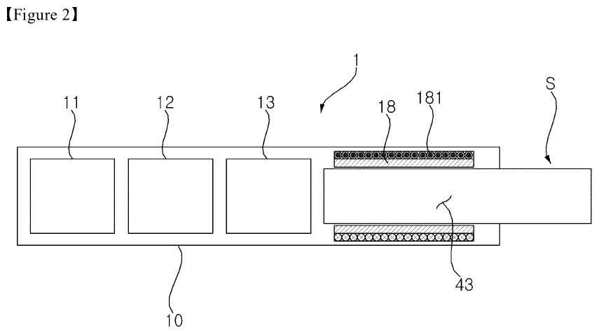

FIGS. 1 and 2 are views showing aerosol-generating devices 1 according to embodiments of the present disclosure.

Referring to FIGS. 1 and 2, an aerosol-generating device 1 according to embodiments of the present disclosure may include at least one of a power supply 11, a controller 12, a sensor 13, or a heater 18. At least one of the power supply 11, the controller 12, the sensor 13, or the heater 18 may be disposed in a body 10 of the aerosol-generating device. The body 10 may define a space having an open top to allow a stick S, which is an aerosol-generating article, to be inserted thereinto. The space having an open top may be referred to as an insertion space 43. The insertion space 43 may be formed so as to be depressed to a predetermined depth toward the interior of the body 10 so that the stick S is inserted at least partway thereinto. The depth of the insertion space 43 may correspond to the length of the portion of the stick S that contains an aerosol-generating substance and/or medium. The lower end of the stick S may be inserted into the body 10, and the upper end of the stick S may protrude to the outside of the body 10. A user may inhale air in a state of holding the upper end of the stick S, which is exposed to the outside, in the mouth.

The heater 18 may heat a stick S. The heater 18 may be disposed around a space into which the stick S is inserted and may be elongated upward. For example, the heater 18 may be formed in a shape of a tube including a cavity formed therein. The heater 18 may be disposed around an insertion space 43. The heater 18 may be disposed so as to surround at least a portion of the insertion space 43. The heater 18 may heat the insertion space 43 or the stick S inserted into the insertion space 43. The heater 18 may include an electro-resistive heater and/or an induction heater.

For example, referring to FIG. 1, the heater 18 may be a resistive heater. For example, the heater 18 may include an electrically conductive track and may be heated as current flows through the electrically conductive track. The heater 18 may be electrically connected to the power supply 11. The heater 18 may directly generate heat using current received from the power supply 11.

For example, referring to FIG. 2, the aerosol-generating device may include an induction coil 181 surrounding the heater 18. The induction coil 181 may cause the heater 18 to generate heat. The heater 18 may generate heat using a magnetic field generated by alternating current flowing through the induction coil 181. The magnetic field may pass through the heater 18 to generate an eddy current in the heater 18. The current may cause the heater 18 to generate heat.

Meanwhile, a susceptor may be included in the stick S, and the susceptor in the stick S may generate heat using a magnetic field generated by alternating current flowing through the induction coil 181.

The power supply 11 may supply power so that components of the aerosol-generating device operate. The power supply 11 may be referred to as a battery. The power supply 11 may supply power to at least one of the controller 12, the sensor 13, or the heater 18. The power supply 11 may supply power to the induction coil 181.

The controller 12 may control overall operation of the aerosol-generating device. The controller may be mounted on a printed circuit board (PCB). The controller 12 may control operation of at least one of the power supply 11, the sensor 13, or the heater 18. The controller 12 may control operation of a display, a motor, etc. mounted in the aerosol-generating device. The controller 12 may check the state of each of the components of the aerosol-generating device and may determine whether the aerosol-generating device is in an operable state.

The controller 12 may analyze a result of detection by the sensor 13 and may control subsequent processes. For example, the controller 12 may control, based on a result of detection by the sensor 13, power supplied to the heater 18 so that operation of the heater 18 commences or ends. For example, the controller 12 may control, based on a result of detection by the sensor 13, the amount of power supplied to the heater 18 and a power supply time so that the heater 18 is heated to a predetermined temperature or is maintained at an appropriate temperature.

The sensor 13 may include at least one of a temperature sensor, a puff sensor, or an insertion detection sensor. For example, the sensor 13 may detect at least one of the temperature of the heater 18, the temperature of the power supply 11, or the internal/external temperature of the body 10. For example, the sensor 13 may detect a user puff. For example, the sensor 13 may detect whether the stick S is inserted into the insertion space 43.

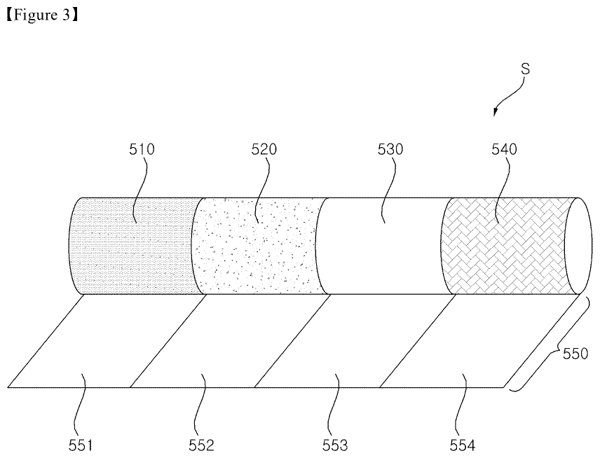

FIG. 3 is a view showing a stick according to an embodiment of the present disclosure.

Referring to FIG. 3, the stick S may include an aerosol base portion 510. The stick S may include a medium portion 520. The aerosol base portion 510 and the medium portion 520 may be referred to as a tobacco rod. The stick S may include a cooling portion 530. The stick S may include a filter portion 540. The stick S may include a wrapper 550 that surrounds the aerosol base portion 510, the medium portion 520, the cooling portion 530 and/or the filter portion 540. In FIG. 3, the wrapper 550 may include individual wrappers that surround the aerosol base portion 510, the medium portion 520, and the filter portion 540, respectively, and/or an outer shell that surrounds the aerosol base portion 510, the medium portion 520, and the filter portion 540, which are surrounded by the individual wrappers, in one piece.

The aerosol base portion 510 may be a portion formed in a preset shape by containing a moisturizer in pulp-based paper. The moisturizer (a base material) contained in the aerosol base portion 510 may include propylene glycol and glycerin. For example, the moisturizer of the aerosol base portion 510 may include propylene glycol and glycerin having a certain weight ratio to the weight of base paper. When the stick S is inserted into the aerosol-generating device 1 and is heated to a temperature above a predetermined level by the heater 18, moisturizer vapor may be generated from the aerosol base portion 510.

The medium portion 520 may include at least one of a sheet, a strand, or pipe tobacco formed of tiny bits of a shredded tobacco sheet. The medium portion 520 may be a portion that generates nicotine in order to provide a smoking experience to a user. When the temperature of the medium contained in the medium portion 520 rises to a predetermined temperature or higher, nicotine vapor may be generated from the medium portion 520. When the stick S is inserted into the aerosol-generating device 1, at least part of the aerosol base portion 510 and at least part of the medium portion 520 may face the heater 18. For example, a part of the upstream side or the downstream side of the aerosol base portion 510 and a part of the downstream side or the upstream side of the medium portion 520 may face the heater 18.

The length of the part of the medium portion 520 that faces the heater 18 may be greater than the length of the part of the aerosol base portion 510 that faces the heater 18. The length of the part of the aerosol base portion 510 that faces the heater 18 may be greater than or equal to half the overall length of the aerosol base portion 510. The length of the part of the medium portion 520 that faces the heater 18 may be greater than or equal to half the overall length of the medium portion 520.

The part of the aerosol base portion 510 and the part of the medium portion 520 that face the heater 18 may be heated by the heater 18. Because at least part of the aerosol base portion 510 containing the moisturizer is heated by the heater 18, moisturizer vapor may be generated. Because at least part of the medium portion 520 containing the medium is heated by the heater 18, nicotine vapor may be generated. As the stick S is disposed so as to vary a ratio of the length of the part of the aerosol base portion 510 that faces the heater 18 to the length of the part of the medium portion 520 that faces the heater 18, a ratio of the amount of moisturizer vapor generated to the amount of nicotine vapor generated may be appropriately adjusted.

In an embodiment, although the stick S is inserted into the aerosol-generating device 1, the medium portion 520 may not be directly heated by the heater 18. The medium portion 520 may be indirectly heated from the aerosol base portion 510 and the medium-portion wrapper (or the wrapper) surrounding the medium portion 520 through conduction, convection, and radiation. After the aerosol base portion 510 is heated through the heater 18, the temperature of the medium portion 520 may be indirectly increased.

The cooling portion 530 may be manufactured as a tube filter containing a predetermined weight of plasticizer. The moisturizer vapor and the nicotine vapor generated from the aerosol base portion 510 and the medium portion 520 may be mixed with each other to be aerosolized, and may be cooled while passing through the cooling portion 530. According to an embodiment, the cooling portion 530 may not be surrounded by the individual wrapper, unlike the aerosol base portion 510, the medium portion 520, and the filter portion 540.

The filter portion 540 may be a cellulose acetate filter. Meanwhile, there is no limitation on the shape of the filter portion 540. The filter portion 540 may be a cylindrical-type rod or may be of a tube type including a cavity formed therein. For example, when the filter portion 540 is composed of a plurality of segments, at least one of the plurality of segments may be manufactured in a different shape. The filter portion 540 may be manufactured so as to generate a flavor. In an example, a flavoring agent may be sprayed to the filter portion 540, or a separate fiber coated with a flavoring agent may be inserted into the filter portion 540.

In addition, the filter portion 540 may include at least one capsule. Here, the capsule may perform a function of generating a flavor. For example, the capsule may be a structure that encapsulates a liquid containing a flavoring agent with a film, and may have a spherical or cylindrical shape. However, the disclosure is not limited thereto.

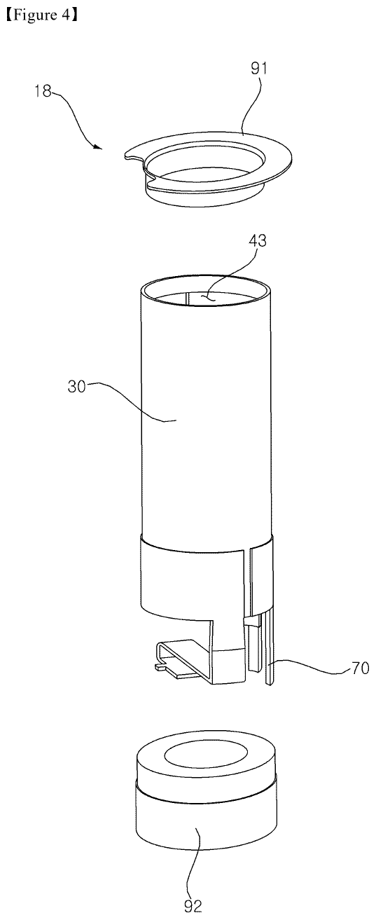

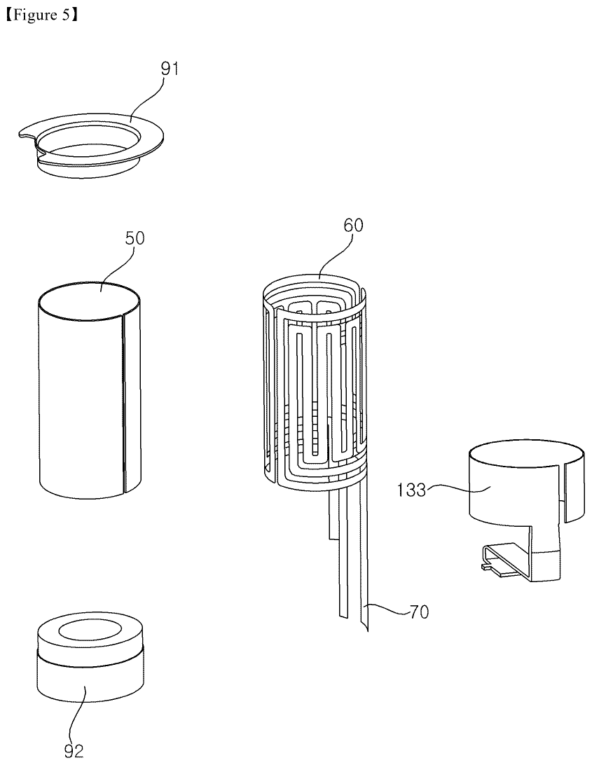

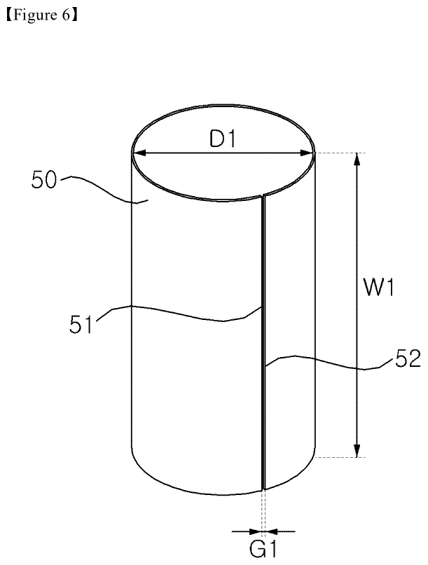

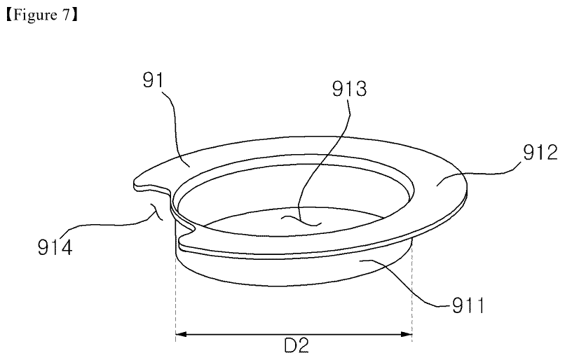

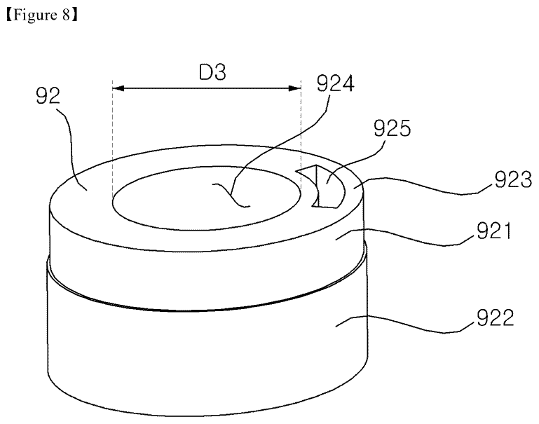

FIG. 4 is a front perspective view of a heater assembly according to an embodiment of the present disclosure, FIG. 5 is an exploded perspective view of the heater assembly according to the embodiment of the present disclosure, FIG. 6 is a view showing a susceptor of the heater assembly according to the embodiment of the present disclosure, and FIGS. 7 and 8 are views showing brackets of the heater assembly according to the embodiment of the present disclosure.

Referring to FIG. 4, the heater 18 may include a heater assembly 30. The heater assembly 30 may be elongated. The heater assembly 30 may have a tubular shape or a cylindrical shape including a cavity formed therein. The heater assembly 30 may be disposed in the body 10 of the aerosol-generating device 1. The heater assembly 30 may surround the insertion space 43 (refer to FIGS. 1, 2). The heater assembly 30 may provide the insertion space 43. The insertion space 43 or the stick S inserted into the insertion space 43 may be heated by the heater assembly 30. The heater assembly 30 may include a leads 70 that protrude outwardly and are electrically connected to the power supply 11.

The heater 18 may include a pair of brackets 91 and 92. The pair of brackets 91 and 92 may be coupled to the top and bottom of the heater assembly 30, respectively. The pair of brackets 91 and 92 may be coupled to the heater assembly 30 to support the heater assembly 30.

Referring to FIG. 5, the heater assembly 30 may include a susceptor 50, an electrically conductive track 60, and a lead 70.

The susceptor 50 may have a cylindrical shape. The susceptor 50 may be disposed inside the electrically conductive track 60. The susceptor 50 may surround at least a portion of the insertion space 43. The susceptor 50 may be referred to as a heat conductor, a heat conducting part, a heat diffusing part, or a pipe. The susceptor 50 may be made of stainless steel, aluminum, or an alloy thereof without being limited thereto.

The electrically conductive track 60 may have a cylindrical shape. The electrically conductive track 60 may be disposed outside the susceptor 50. The electrically conductive track 60 may surround at least a portion of the susceptor 50. The electrically conductive track 60 may be formed by etching a thin metal film using a laser. The electrically conductive track 60 may generate heat in response to power received from the power supply 11. The electrically conductive track 60 may be referred to as a heat-generating part. The electrically conductive track 60 may be made of stainless steel, copper, aluminum, or alloys thereof without being limited thereto.

An insulator (not shown) may be disposed on one side of the electrically conductive track 60. The insulator may be disposed inside and/or outside the electrically conductive track 60 and may have a cylindrical shape. The insulator may form at least one layer. The insulator may cover the electrically conductive track 60. The insulator may extend farther upward and downward than the electrically conductive track 60 in the longitudinal direction of the insertion space 43.

The insulator may be formed of a flexible and heat-resistant material. The insulator may include, but is not limited to, polyimide or polyetheretherketone (PEEK), and may include other materials having elasticity, heat resistance, and electrical insulation.

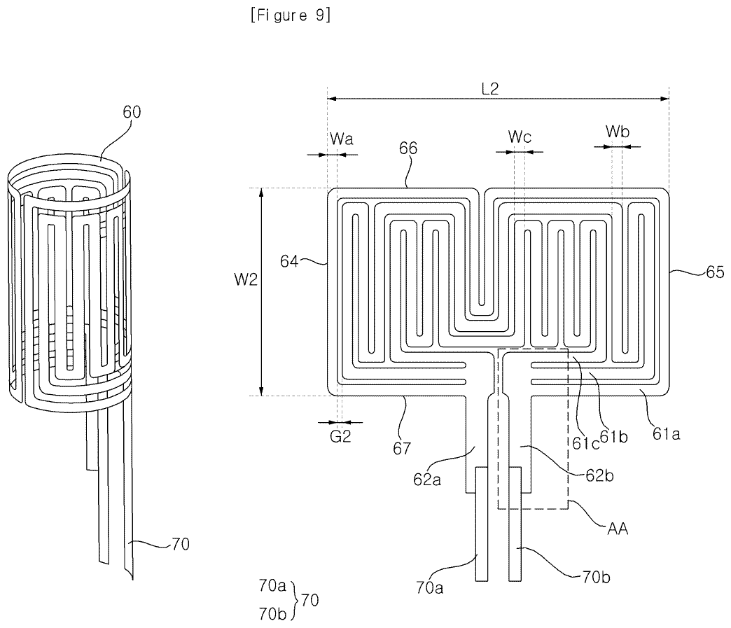

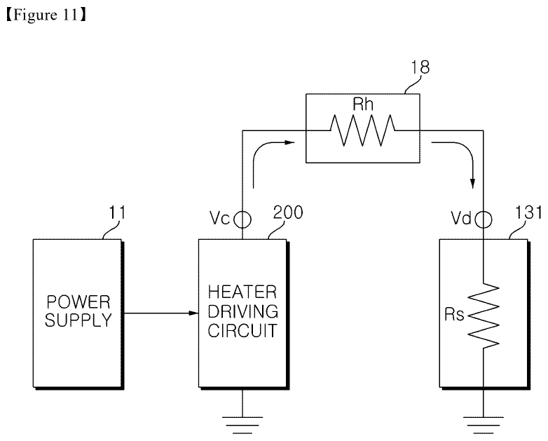

The lead 70 may be connected to the electrically conductive track 60. The lead 70 may be elongated from one side of the electrically conductive track 60 to protrude therefrom. The lead 70 may protrude downward below the insulator extending farther downward than the electrically conductive track 60. The lead 70 may be exposed from the insulator. The lead 70 may be electrically connected to the electrically conductive track 60 and a circuit board 200 (refer to FIG. 11). Features related to the electrically conductive track 60 and the lead 70 will be described in detail with reference to FIGS. 9 to 13.

The heater assembly 30 may be combined with brackets 91 and 92. The first bracket 91 may be attached or coupled to an upper side of the heater assembly 30 corresponding to the opening of the insertion space 43. The second bracket 92 may be attached or coupled to a lower side of the heater assembly 30.

A stick detection sensor 133 may be disposed on the heater assembly 30. The stick detection sensor 133 may detect insertion and/or removal of the stick S. The stick detection sensor 133 may be disposed so as to surround at least a portion of the lower side of the heater assembly 30. The stick detection sensor 133 may be disposed below the susceptor 50 and the electrically conductive track 60 in the longitudinal direction of the insertion space 43. The stick detection sensor 133 may be disposed so as to be in contact with the portion of the insulator that extends downward below the electrically conductive track 60 and to surround a portion of the periphery of the insulator. The stick detection sensor 133 may be spaced apart from the susceptor 50 and the electrically conductive track 60 in the longitudinal direction of the insertion space 43.

Accordingly, transfer of heat generated by the susceptor 50 and the electrically conductive track 60 to the sensor 133 may be minimized. In addition, the accuracy of detection of the stick S by the sensor 133 may be increased.

Referring to FIG. 6, the susceptor 50 may have a cylindrical shape. The width W1 of the susceptor 50 defined in the longitudinal direction of the insertion space 43 may be 10 mm to 20 mm. In some embodiments, the width W1 of the susceptor 50 may be 12.5 mm to 17.5 mm. The susceptor 50 having a cylindrical shape may have a diameter D1 of 7 mm to 8 mm. The thickness of the susceptor 50 defined in the radial direction of the insertion space 43 may be 0.01 mm to 0.03 mm.

One end 51 of the susceptor 50 may be spaced apart from the other end 52 of the susceptor 50 in the peripheral direction of the susceptor 50 or the peripheral direction of the insertion space 43. A gap G1 may be formed between one end 51 and the other end 52 of the susceptor. The width of the gap G1 may be 0.5 mm or less. As the width of the gap G1 increases, the area of a portion of the stick S that is not heated due to the gap G1 may increase. Therefore, 0.5 mm may correspond to an upper limit width at which an aerosol is generated from the stick S in a preset minimum required amount or more.

Accordingly, it may be possible to prevent a phenomenon that the shape of the susceptor 50 is distorted or parts of the susceptor 50 overlap each other in the process of manufacturing the susceptor 50 or the process in which the susceptor 50 is heated or cooled.

Referring to FIGS. 7 and 8, the heater assembly 30 may be combined with brackets 91 and 92. The first bracket 91 may be attached or coupled to an upper side of the heater assembly 30 corresponding to the opening of the insertion space 43. The first bracket 91 may include a first bracket body 911, a first flange 912, an insertion hole 913, and an alignment recess 914.

The first bracket body 911 may have a cylindrical shape. The outer diameter D2 of the first bracket body 911 may be equal to or greater than the diameter of the upper end portion of the heater assembly 30. The first bracket body 911 may extend in the peripheral direction. The first bracket body 911 may be attached to or press-fitted into the upper end portion of the heater assembly 30. The first flange 912 may protrude from the upper end portion of the first bracket body 911 in the radially outward direction. The first flange 912 may extend in the peripheral direction. The first flange 912 may surround the upper end portion of the first bracket body 911. The insertion hole 913 may be formed so as to penetrate the central portion of the first bracket 91 in the upward-downward direction. The boundary portion between the first flange 912 and the first bracket body 911 may have a shape that is convexly bent from the inner circumferential surface of the first bracket body 911 to the upper surface of the first flange 912. The alignment recess 914 may be formed by depressing one side of the flange 912 in the radially inward direction. The alignment recess 914 may have a shape corresponding to a protrusion formed at the body 10. The alignment recess 914 may be coupled to the protrusion formed at the body 10. Due to the alignment recess 914, the heater assembly 30 may be prevented from rotating in the body 10 and may be stably coupled to the body 10. The first bracket 91 may be made of stainless steel, aluminum, polyetheretherketone (PEEK), or alloys thereof without being limited thereto.

The second bracket 92 may be attached or coupled to a lower side of the heater assembly 30. The second bracket 92 may include a second bracket body 921, a second flange 922, and a first hole 924.

The second bracket body 921 may have a cylindrical shape. The outer diameter of the second bracket body 921 may be equal to or greater than the diameter of the lower end portion of the heater assembly 30, and the inner diameter D3 of the second bracket body 921 may be less than the diameter of the lower end portion of the heater assembly 30. The second bracket body 921 may extend in the peripheral direction. The second bracket body 921 may be attached to or press-fitted into the lower end portion of the heater assembly 30. The second flange 922 may protrude from the lower end portion of the second bracket body 921 in the radially outward direction. The second flange 922 may extend in the peripheral direction. The second flange 922 may surround the lower end portion of the second bracket body 921. The first hole 924 may be formed so as to penetrate the central portion of the second bracket 92 in the upward-downward direction.

The first bracket 91 and the second bracket 92 may support the upper end and the lower end of the heater assembly 30, respectively. The upper end of the heater assembly 30 may be fixed to or supported by the first bracket 91. The lower end of the heater assembly 30 may be fixed to or supported by the second bracket 92.

Accordingly, both ends of the heater assembly 30 including the susceptor 50 and the electrically conductive track 60 may be stably fixed, and thus the rigidity of the heater assembly 30 may be ensured.

The second bracket 92 may include a second hole 925 formed through the second bracket body 921 and the second flange 922 while being spaced apart from the first hole 924. When the second bracket 92 is coupled to the lower end of the heater assembly 30, the lead 70 may pass through the second hole 925 in the second bracket 92, and one end of the lead 70 may protrude downward below the second bracket 92. The protruding end of the lead 70 may be connected to the power supply 11 or the circuit board 200 via a wire, a bridge, or the like.

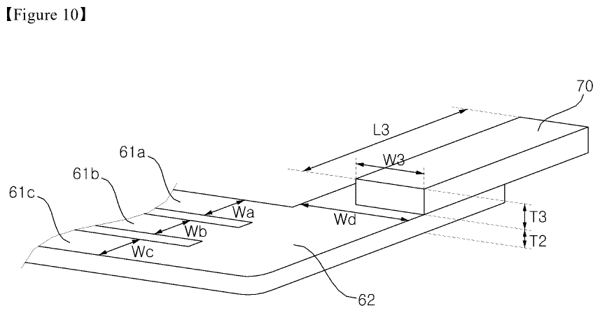

FIG. 9 is a view showing the electrically conductive track of the heater assembly according to the embodiment of the present disclosure, and FIG. 10 is a perspective view showing portion AA of the electrically conductive track in FIG. 9 in an enlarged manner.

Referring to FIG. 9, the electrically conductive track 60 may have a cylindrical shape. The electrically conductive track 60 may generate heat in response to power received from the power supply 11. Heat generated from the electrically conductive track 60 may heat a medium and/or a moisturizer in the stick S inserted into the insertion space 43, whereby an aerosol may be generated. The electrically conductive track 60 may generate heat to a set temperature or lower. For example, the electrically conductive track 60 may generate heat to a temperature of 270° C. or lower.

In an unfolded state of the electrically conductive track 60, the electrically conductive track 60 may be elongated in one direction. The electrically conductive track 60 may have a rectangular shape in which the length L2 thereof is greater than the width W2 thereof. The length L2 of the electrically conductive track 60 may be 18 mm to 28 mm, and the width W2 of the electrically conductive track 60 may be 10 mm to 20 mm. In some embodiments, the length L2 of the electrically conductive track 60 may be 20.5 mm to 25.5 mm, and the width W2 of the electrically conductive track 60 may be 12.5 mm to 17.5 mm. The thickness T2 of the electrically conductive track 60 may be 0.03 mm to 0.05 mm.

The electrically conductive track 60 may include a heat-generating track 61 and a connection portion 62. The heat-generating track 61 may include one or more tracks 61a, 61b, and 61c. The first track 61a may be disposed at the outermost portion of the electrically conductive track 60 and may have a rectangular shape overall. The second track 61b may be disposed inside the first track 61a, and the third track 61c may be disposed inside the second track 61b.

Each of the first to third tracks 61a, 61b, and 61c may include at least one bent portion and may have a serpentine shape. The number of bent portions of the first track 61a may be less than the number of bent portions of the second track 61b. The number of bent portions of the second track 61b may be less than the number of bent portions of the third track 61c. The first to third tracks 61a, 61b, and 61c may be spaced apart from each other. One end of each of the first to third tracks 61a, 61b, and 61c may be connected to one end of each of the other tracks, and the other end of each of the first to third tracks 61a, 61b, and 61c may be connected to the other end of each of the other tracks. In other words, the first to third tracks 61a, 61b, and 61c may be connected in parallel to each other.

The width Wa of the first track 61a may be 0.5 mm to 0.7 mm. The width Wb of the second track 61b may be 0.6 mm to 0.8 mm. The width Wc of the third track 61c may be 0.65 mm to 0.85 mm. A gap G2 by which the second track 61b is spaced apart from the first track 61a or the third track 61c may be 0.3 mm to 0.4 mm.

The width Wa of the first track 61a may be less than or equal to the width Wb of the second track 61b. The width Wb of the second track 61b may be less than or equal to the width Wc of the third track 61c.

The length of the first track 61a may be less than or equal to the length of the second track 61b. The length of the second track 61b may be less than or equal to the length of the third track 61c.

The gap G2 by which the second track 61b is spaced apart from the first track 61a or the third track 61c may be less than the width Wa of the first track 61a, the width Wb of the second track 61b, and the width Wc of the third track 61c.

Accordingly, resistance deviation between the first track 61a disposed at the outermost portion of the electrically conductive track 60, the second track 61b disposed inside the first track 61a, and the third track 61c disposed inside the second track 61b may be reduced, and deviation between the amounts of heat generated from the respective tracks may be reduced.

In addition, because the gap between the tracks is less than the widths of the tracks, the heat-generating area of the electrically conductive track 60 may be increased, and the insertion space 43 or the stick S inserted into the insertion space 43 may be evenly heated by the electrically conductive track 60.

The connection portion 62 may protrude outwardly from one side of the heat-generating track 61. The connection portion 62 may be integrally formed with the heat-generating track 61. The connection portion 62 may be exposed from the insulator covering the electrically conductive track 60. The connection portion 62 may include a first connection portion 62a and a second connection portion 62b. The first connection portion 62a may be connected to one end of each of the first to third tracks 61a, 61b, and 61c, and the second connection portion 62b may be connected to the other end of each of the first to third tracks 61a, 61b, and 61c.

The lead 70 may be connected to the electrically conductive track 60. The lead 70 may be connected to the connection portion 62. The lead 70 may be elongated in the direction in which the connection portion 62 protrudes. The lead 70 may electrically connect the electrically conductive track 60 to the power supply 11 or the circuit board 200. The lead 70 may include a first lead 70a in contact with the first connection portion 62a and a second lead 70b in contact with the second connection portion 62b. Power may be supplied to the electrically conductive track 60 via the first lead 70a and the second lead 70b. The lead 70 may be attached to the connection portion 62 through welding. However, the method of attaching the lead 70 to the connection portion 62 is not limited thereto.

Referring to FIG. 10, the lead 70 may have a plate shape. The lead 70 may have a predetermined thickness and may extend flatly in the direction in which the connection portion 62 extends.

The heating characteristics may vary depending on the shape of the lead even when the lead has a given volume and/or a given length. When the lead 70 has a flat plate shape, change in the temperature thereof caused by heat generated by the electrically conductive track 60 may be less than when the lead 70 has a cylindrical shape. Accordingly, when the heater operates, heating of parts other than the heater by the lead 70 may be minimized.

The lead 70 may be formed such that the width W3 and the length L3 thereof are greater than the thickness T3 thereof. The lead 70 may protrude downward below the second bracket 92 through the second bracket 92 coupled to the lower side of the heater assembly 30. The lead 70 may pass through the second hole 925 in the second bracket 92 and may protrude downward below the second bracket 92.

The length L3 of the lead 70 may be less than the lengths of the heat-generating tracks 61a, 61b, and 61c of the electrically conductive track 60. The width W3 of the lead 70 may be greater than or equal to the widths Wa, Wb, and Wc of the heat-generating tracks 61a, 61b, and 61c of the electrically conductive track 60. The thickness T3 of the lead 70 may be greater than the thickness T2 of the heat-generating tracks 61a, 61b, and 61c or the connection portion 62.

The ratio of the lengths of the heat-generating tracks 61a, 61b, and 61c to the length L3 of the lead 70 may be 20:1 to 25:1. The ratio of the widths Wa, Wb, and Wc of the heat-generating tracks 61a, 61b, and 61c to the W3 of the lead 70 may be 1:1 to 1:1.3. The ratio of the thickness T2 of the heat-generating tracks 61a, 61b, and 61c or the connection portion 62 to the thickness T3 of the lead 70 may be 1:8 to 1:12.

For example, the lengths of the heat-generating tracks 61a, 61b, and 61c may be 90 mm to 110 mm, and the length L3 of the lead 70 may be 4 mm to 5 mm. The widths Wa, Wb, and Wc of the heat-generating tracks 61a, 61b, and 61c may be 0.5 mm to 0.9 mm, and the width W3 of the lead 70 may be 0.7 mm to 0.9 mm. The thickness T2 of the electrically conductive track 60 or each of the heat-generating tracks 61a, 61b, and 61c may be 0.03 mm to 0.05 mm, and the thickness T3 of the lead 70 may be 0.3 mm to 0.5 mm.

The lead 70 may have a smaller resistance value than the electrically conductive track 60. The resistance value of the lead 70 may be less than that of the electrically conductive track 60 within a temperature range within which the electrically conductive track 60 is heated.

The electrically conductive track 60 may generate heat or be heated to a set temperature or lower. For example, the electrically conductive track 60 may generate heat or be heated to a temperature of 270° C. or lower. Because the electrically conductive track 60 generates heat or is heated to a temperature of 270° C. or lower, an aerosol may be generated without burning the stick S received in the insertion space 43.

At the temperature of 270° C. or lower, the ratio of the resistance value of the electrically conductive track 60 to the resistance value of the lead 70 may be 90:1 to 110:1. For example, at the temperature of 270° C. or lower, the electrically conductive track 60 may have a resistance value of 0.9 to 1.4 ohms. At the temperature of 270° C. or lower, the lead 70 may have a resistance value of 0.008 to 0.012 ohms.

Because the resistance value of the lead is much less than the resistance value of the electrically conductive track, it may be possible to reduce the amount of heat generated from the lead and to increase the heating efficiency of the heater.

In addition, because the resistance value of the lead is much less than the resistance value of the electrically conductive track, it may be possible to prevent parts other than the heater in the device from being heated.

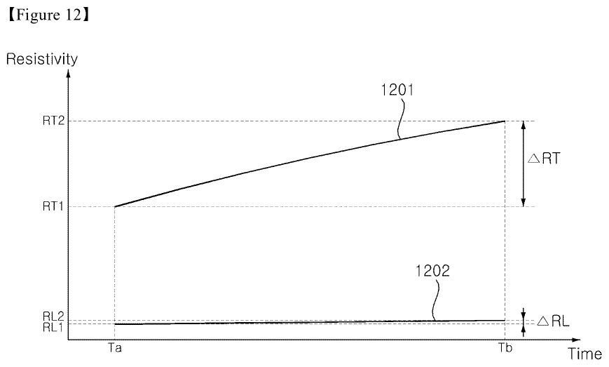

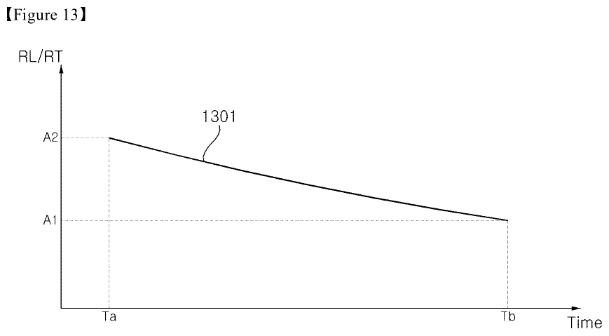

FIG. 11 is a diagram illustrating a circuit for measurement of the resistance of the heater in the aerosol-generating device according to the embodiment of the present disclosure, FIG. 12 is a graph illustrating change in resistance value depending on heating of the heater assembly according to the embodiment of the present disclosure, and FIG. 13 is a graph illustrating change in the ratio of the resistance value of the lead to the resistance value of the electrically conductive track depending on heating of the heater assembly according to the embodiment of the present disclosure.

Referring to FIG. 11, a resistance measurement sensor 131 may be configured as a sensor that detects the resistance value Rh of the heater 18. Here, the resistance value Rh of the heater 18 may be defined as a sum of the resistance value RT of the electrically conductive track 60 and the resistance value RL of the lead 70. The resistance measurement sensor may be referred to as a temperature sensor. The resistance measurement sensor 131 may output a signal corresponding to the resistance value Rh of the heater 18.

The resistance measurement sensor 131 may be electrically connected to the heater 18. The heater driving circuit 200 may supply power to the heater 18 using the power stored in the power supply 11. The heater driving circuit may be referred to as a circuit board. The power supplied to the heater 18 through the heater driving circuit 200 may be controlled by the controller 12.

The controller 12 may control, based on the temperature of the heater 18, the power supplied to the heater 18. The controller 12 may determine, based on the resistance value Rh of the heater 18, the temperature of the heater 18, and may control, based on the determined temperature of the heater 18, the power supplied to the heater 18 within at least one heating section of the heating profile.

The circuit board 200 may transmit electrical signals for control of operation of various components. A circuit pattern for transmission of electrical signals may be formed on the circuit board 200. The circuit board 200 may be electrically connected to the power supply 11 and the controller 12. The controller 12 may be mounted on the circuit board 200.

Currents having the same level may flow through the heater 18 and the resistance measurement sensor 131. The resistance value Rs of a shunt resistor provided in the resistance measurement sensor 131 may be a value that does not vary depending on temperature.

The controller 12 may determine voltage Vc applied to the heater 18 and the resistance measurement sensor 131 based on the power supplied to the heater 18 from the heater driving circuit 200 and the current flowing through the heater 18 and the resistance measurement sensor 131. The controller 12 may calculate voltage Vd applied to the shunt resistor of the resistance measurement sensor 131 based on the current flowing through the shunt resistor and the resistance value Rs of the shunt resistor. The controller 12 may calculate, as the voltage applied to the heater 18, a difference (Vc−Vd) between the voltage Vc applied to the heater 18 and the resistance measurement sensor 131 and the voltage Vd applied to the shunt resistor. The controller 12 may calculate the resistance value Rh of the heater 18 based on the voltage applied to the heater 18 and the current flowing through the heater 18.

The resistor of the heater 18 may be formed of a material having a temperature coefficient of resistance, and the resistance value Rh of the heater 18 may vary depending on the temperature of the resistor. The controller 12 may calculate the temperature of the heater 18 corresponding to the temperature coefficient of resistance of the heater 18, the resistance value Rh of the heater 18, and a resistance value of the heater 18 at a reference temperature using a calculation formula for calculating the temperature of the heater 18. Here, the calculation formula for calculating the temperature of the heater 18 may correspond to Equation 1 below.

$$TCR = \frac{R 1 - R 0}{R 0} \div ( T 1 - T 0 ) \qquad [ Equation 1 ]$$

In Equation 1 above, TCR represents the temperature coefficient of resistance of the heater 18, T1 represents the temperature of the heater 18, R1 represents the resistance value of the heater 18, T0 represents the reference temperature, and R0 represents the resistance value of the heater 18 at the reference temperature. Here, TO may be 25° C., and R0 may be the resistance value of the heater 18 at 25° C.

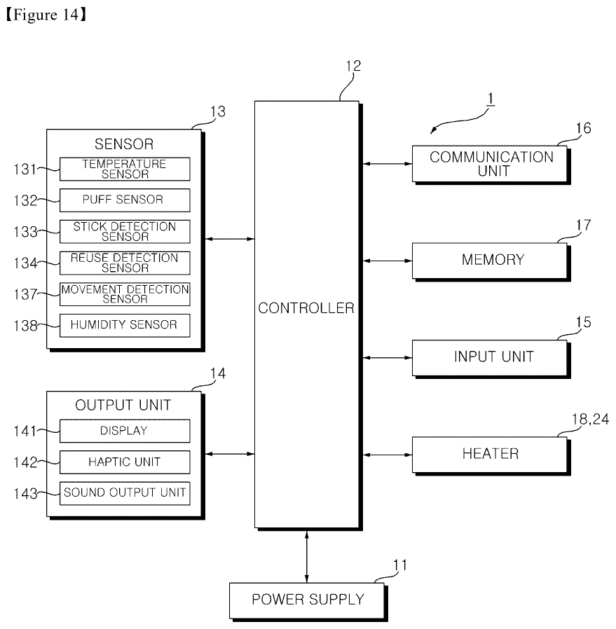

The resistance value of the heater 18 at the reference temperature may vary depending on aerosol-generating devices. In consideration thereof, data on the resistance value of the heater 18 may be stored in a memory 17 (refer to FIG. 14) of the aerosol-generating device 1. The controller 12 may determine, based on the data stored in the memory 17, the resistance value R0 of the heater 18 at the reference temperature TO, which is used in the calculation formula for calculating the temperature of the heater 18.

Although the resistance measurement sensor 131 is illustrated as being connected in series to the heater 18 in the drawings by way of example, the disclosure is not limited thereto. The resistance measurement sensor 131 may be implemented as a voltage sensor configured to detect the voltage applied to the heater 18.

The resistance value Rh of the heater 18 measured by the resistance measurement sensor 131 may be a value obtained by summing the resistance value RT of the electrically conductive track 60 and the resistance value RL of the lead 70. When the controller 12 controls the heating temperature of the heater 18 based on the resistance value Rh of the heater 18, the resistance value RL of the lead 70 and/or change in the resistance value RL may act as noise.

In the heater assembly 30 according to the embodiment of the present disclosure, the lead 70 may include a material having a much lower temperature coefficient of resistance than the electrically conductive track 60.

The lead 70 may have a temperature coefficient of resistance in the range of 6 to 10 ppm/° C. In some embodiments, the lead 70 may have a temperature coefficient of resistance in the range of 7 to 9 ppm/° C.

For example, the lead 70 may include an alloy containing nickel and copper. The lead 70 may include an alloy containing nickel and copper in a ratio of 40:60 to 50:50 by weight. In some embodiments, the lead 70 may include an alloy containing 45 wt % nickel and 55 wt % copper. If the weight percent of nickel is less than 40 and the weight percent of copper is greater than 60, the temperature coefficient of resistance of the lead 70 may be greater than 10 ppm/° C. If the weight percent of nickel is greater than 50 and the weight percent of copper is less than 50, the temperature coefficient of resistance of the lead 70 may be greater than 10 ppm/° C. Because the lead 70 includes an alloy containing nickel and copper in a ratio of 40:60 to 50:50 by weight, the temperature coefficient of resistance of the lead 70 may be less than 10 ppm/° C.

The lead 70 may include constantan. The lead 70 may be formed of constantan. As shown in Table 1 below, constantan has a temperature coefficient of resistance of about 8 ppm/° C. Constantan has a very small temperature coefficient of resistance compared to electrically conductive materials, such as copper and SUS316, used for the electrically conductive track 60. However, the material forming the lead 70 is not limited thereto, and may be another material having a temperature coefficient of resistance of 6 to 10 ppm/° C. as described above.

TABLE 1

| Classification | Copper | SUS316 | Constantan |
|---|---|---|---|
| TCR (ppm/° C.) | 3900 | 920 | 8 |

The electrically conductive track 60 may include copper or SUS316. The electrically conductive track 60 may be formed of copper or SUS316. The electrically conductive track 60 may have a temperature coefficient of resistance of 500 ppm/° C. or higher. If the electrically conductive track 60 has a small temperature coefficient of resistance below a certain level, change in the resistance value RT of the electrically conductive track 60 depending on change in the temperature thereof is small. Thus, it may be inaccurate to calculate or determine the temperature of the electrically conductive track 60 based on the resistance value RT of the electrically conductive track 60. If the electrically conductive track 60 has a large temperature coefficient of resistance above a certain level, the resistance value RT of the electrically conductive track 60 greatly increases in accordance with increase in the temperature thereof. Thus, the amount of power required to heat the electrically conductive track 60 may increase, and heating efficiency may deteriorate.

The ratio of the temperature coefficient of resistance of the electrically conductive track 60 to the temperature coefficient of the lead 70 may be 100:1 to 500:1. If the temperature coefficient of resistance of the electrically conductive track 60 is less than 100 times the temperature coefficient of resistance of the lead 70, the degree to which the resistance value RL of the lead 70 changes as the heater generates heat may be unnecessarily large. Thus, the temperature of the heater 18 calculated or determined based on the resistance value Rh of the heater 18 may be inaccurate.

If the temperature coefficient of resistance of the electrically conductive track 60 is greater than 500 times the temperature coefficient of resistance of the lead 70, the degree to which the resistance value RT of the electrically conductive track 60 changes as the heater generates heat may be unnecessarily large. Thus, the amount of power required to heat the electrically conductive track 60 may increase, and heating efficiency may deteriorate.

Referring to FIG. 12, as power is applied to the heater 18, the electrically conductive track 60 and the lead 70 may generate heat or be heated. When the electrically conductive track 60 and the lead 70 generate heat or are heated from a first time point Ta to a second time point Tb, the resistance value RT of the electrically conductive track 60 may increase from a first value RT1 to a second value RT2, and the resistance value RL of the lead 70 may increase from a third value RL1 to a fourth value RL2.

For example, the electrically conductive track 60 may generate heat or be heated from room temperature or 25° C. to 270° C. In this case, during the same time period (Tb-Ta), the change ΔRT in the resistance value of the electrically conductive track 60 may be greater than the change ΔRL in the resistance value of the lead 70. The change ΔRT in the resistance value of the electrically conductive track 60 may be obtained by multiplying the resistance value RT of the electrically conductive track 60 by the increased temperature thereof by the temperature coefficient of resistance thereof. The change ΔRL in the resistance value of the lead 70 may be obtained by multiplying the resistance value RL of the lead 70 by the increased temperature thereof by the temperature coefficient of resistance thereof. Because the resistance value RT of the electrically conductive track 60 is greater than the resistance value RL of the lead 70 and the temperature coefficient of resistance of the electrically conductive track 60 is greater than the temperature coefficient of resistance of the lead 70, the change ΔRT in the resistance value of the electrically conductive track 60 may be greater than the change ΔRL in the resistance value of the lead 70.

Referring to FIG. 13, when the electrically conductive track 60 and the lead 70 generate heat or are heated from the first time point Ta to the second time point Tb, the ratio (RL/RT) of the resistance value RL of the lead 70 to the resistance value RT of the electrically conductive track 60 may decrease. As described above with reference to FIG. 12, when the electrically conductive track 60 and the lead 70 generate heat or are heated, the resistance value RT of the electrically conductive track 60 increases more greatly than the resistance value RL of the lead 70. Therefore, the ratio (RL/RT) of the resistance value RL of the lead 70 to the resistance value RT of the electrically conductive track 60 may decrease.

In the state in which the heater 18 is heated to a high temperature, i.e., a set temperature, control of the heating temperature of the heater 18 may be performed at around the set temperature. Because the ratio (RL/RT) of the resistance value RL of the lead 70 to the resistance value RT of the electrically conductive track 60 decreases as the temperature of the heater 18 increases, the temperature of the heater 18 may be accurately calculated or determined based on the resistance value Rh of the heater 18 in a high-temperature section.

FIG. 14 is a block diagram of an aerosol-generating device 1 according to an embodiment of the present disclosure.

The aerosol-generating device 1 may include a power supply 11, a controller 12, a sensor 13, an output unit 14, an input unit 15, a communication unit 16, a memory 17, and one or more heaters 18 and 24. However, the internal structure of the aerosol-generating device 1 is not limited to that shown in FIG. 14. That is, it is to be understood by those skilled in the art that some of the components shown in FIG. 14 may be omitted or new components may be added depending on the design of the aerosol-generating device 1.

The sensor 13 may detect the state of the aerosol-generating device 1 or the state of the surrounding of the aerosol-generating device 1 and may transmit information about the detected state to the controller 12. Based on the information about the detected state, the controller 12 may control the aerosol-generating device 1 to perform various functions, such as control of operation of the cartridge heater 24 and/or the heater 18, smoking restriction, determination as to whether the stick S and/or the cartridge 19 is inserted, and notification display.

The sensor 13 may include at least one of a temperature sensor 131, a puff sensor 132, an insertion detection sensor 133, a reuse detection sensor 134, a movement detection sensor 137, or a humidity sensor 138.

The temperature sensor 131 may detect temperature to which the cartridge heater 24 and/or the heater 18 is heated. The aerosol-generating device 1 may include a separate temperature sensor configured to detect the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element that changes in resistance value according to a change in temperature of the cartridge heater 24 and/or the heater 18. The temperature sensor may be implemented as a thermistor, which is an element characterized in that the resistance thereof changes with temperature. In this case, the temperature sensor 131 may output a signal corresponding to the resistance value of the resistive element as a signal corresponding to the temperature of the cartridge heater 24 and/or the heater 18. For example, the temperature sensor 131 may be configured as a sensor configured to detect the resistance value of the cartridge heater 24 and/or the heater 18. In this case, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be disposed around the power supply 11 to monitor the temperature of the power supply 11. The temperature sensor 131 may be disposed adjacent to the power supply 11. For example, the temperature sensor 131 may be attached to one surface of the battery, which is the power supply 11. For example, the temperature sensor 131 may be mounted on one surface of a printed circuit board.

The temperature sensor 131 may be disposed in the body 10 to detect the internal temperature of the body 10.

The puff sensor 132 may detect a user puff based on various physical changes in a gasflow path. The puff sensor 132 may output a signal corresponding to a puff. For example, the puff sensor 132 may be a pressure sensor. The puff sensor 132 may output a signal corresponding to the internal pressure of the aerosol-generating device. Here, the internal pressure of the aerosol-generating device 1 may correspond to the pressure of the gasflow path through which gas flows. The puff sensor 132 may be disposed at a position corresponding to the gasflow path through which gas flows in the aerosol-generating device 1.

The stick detection sensor 133 may detect insertion and/or removal of the stick S. The stick detection sensor may be referred to as an insertion detection sensor. The insertion detection sensor 133 may detect a signal change caused by insertion and/or removal of the stick S. The insertion detection sensor 133 may be mounted around the insertion space. The insertion detection sensor 133 may detect insertion and/or removal of the stick S according to a change in dielectric constant in the insertion space. For example, the insertion detection sensor 133 may be an inductive sensor and/or a capacitance sensor.

The inductive sensor may include at least one coil. The coil of the inductive sensor may be disposed adjacent to the insertion space. For example, if a magnetic field changes around a coil through which current flows, the characteristics of the current flowing through the coil may change according to Faraday's law of electromagnetic induction. Here, the characteristics of the current flowing through the coil may include a frequency of alternating current, a current value, a voltage value, an inductance value, an impedance value, and the like.

The inductive sensor may output a signal corresponding to the characteristics of the current flowing through the coil. For example, the inductive sensor may output a signal corresponding to the inductance value of the coil.

The capacitance sensor may include a conductive body. The conductive body of the capacitance sensor may be disposed adjacent to the insertion space. The capacitance sensor may output a signal corresponding to the electromagnetic characteristics of the surroundings, for example, the capacitance around the conductive body. For example, if the stick S including a metallic wrapper is inserted into the insertion space, the electromagnetic characteristics around the conductive body may change due to the wrapper of the stick S.

The reuse detection sensor 134 may detect whether the stick S is being reused. The reuse detection sensor 134 may be a color sensor. The color sensor may detect the color of the stick S. The color sensor may detect the color of a portion of the wrap per surrounding the outer side of the stick S. The color sensor may detect, based on light reflected from an object, a value for the optical characteristic corresponding to the color of the object. For example, the optical characteristic may be the wavelength of light. The color sensor may be implemented as a component integrated with a proximity sensor or may be implemented as a component provided separately from a proximity sensor.

At least a portion of the wrapper constituting the stick S may change in color due to an aerosol. The reuse detection sensor 134 may be disposed at a position corresponding to a position at which at least a portion of the wrapper, which changes in color due to an aerosol, is disposed when the stick S is inserted into the insertion space. For example, before the stick S is used by the user, the color of at least a portion of the wrapper may be a first color. In this case, while the aerosol generated by the aerosol-generating device 1 passes through the stick S, at least a portion of the wrapper may become wet due to the aerosol, and accordingly, the color of at least a portion of the wrapper may change to a second color. After changing from the first color to the second color, the color of at least a portion of the wrapper may be maintained in the second color.

The movement detection sensor 137 may detect movement of the aerosol-generating device. The movement detection sensor 137 may be implemented as at least one of an acceleration sensor or a gyro sensor.

The humidity sensor 138 may detect the humidity of the aerosol-generating device and/or the cartridge. The humidity sensor 138 may detect the humidity of outside air and/or the humidity in the cartridge. The humidity sensor 138 may be implemented as a capacitive sensor or the like. The humidity sensor 138 may be disposed on the outer side of the body 10 or may be located in a path through which outside air is introduced to measure the humidity of the surroundings of the aerosol-generating device 1. The humidity sensor 138 may be located in the storage portion CO of the cartridge 19 to measure the humidity in the cartridge 19.

In addition to the sensors 131 to 138 described above, the sensor 13 may further include at least one of a barometric pressure sensor, a magnetic sensor, a position sensor (GPS), or a proximity sensor. The functions of the sensors could be intuitively deduced by those skilled in the art from the names thereof, and thus detailed descriptions thereof will be omitted.

The output unit 14 may output information about the state of the aerosol-generating device 1 and may provide the information to the user. The output unit 14 may include at least one of a display 141, a haptic unit 142, or a sound output unit 143. However, the disclosure is not limited thereto. If the display 141 and a touchpad form a touchscreen together in a layered structure, the display 141 may be used as not only an output device but also an input device.

The display 141 may visually provide information about the aerosol-generating device 1 to the user. For example, the information about the aerosol-generating device 1 may include various pieces of information, such as a charging/discharging state of the power supply 11 of the aerosol-generating device 1, a preheating state of the heater 18, an insertion/removal state of the stick S and/or the cartridge 19, a mounting/removal state of the upper case, and a use restriction state of the aerosol-generating device 1 (e.g., detection of an abnormal article), and the display 141 may output the information to the outside. For example, the display 141 may be in the form of a light-emitting diode (LED) device. For example, the display 141 may be a liquid crystal display panel (LCD), an organic light-emitting display panel (OLED), or the like.

The haptic unit 142 may convert an electrical signal into mechanical stimulation or electrical stimulation to haptically provide the information about the aerosol-generating device 1 to the user. For example, if initial power is supplied to the cartridge heater 24 and/or the heater 18 for a predetermined amount of time, the haptic unit 142 may generate vibration corresponding to completion of initial preheating. The haptic unit 142 may include a vibration motor, a piezoelectric element, or an electrical stimulation device.

The sound output unit 143 may audibly provide information about the aerosol-generating device 1 to the user. For example, the sound output unit 143 may convert an electrical signal into an acoustic signal and may output the acoustic signal to the outside.

The power supply 11 may supply power used for operation of the aerosol-generating device 1. The power supply 11 may supply power so that the cartridge heater 24 and/or the heater 18 is heated. In addition, the power supply 11 may supply power necessary for operation of the other components provided in the aerosol-generating device 1, such as the sensor 13, the output unit 14, the input unit 15, the communication unit 16, and the memory 17. The power supply 11 may be a rechargeable battery or a disposable battery. For example, the power supply 11 may be a lithium polymer (LiPoly) battery. However, the disclosure is not limited thereto.

Although not shown in FIG. 14, the aerosol-generating device 1 may further include a power supply protection circuit. The power supply protection circuit may be electrically connected to the power supply 11 and may include a switching element.

The power supply protection circuit may block an electric path to the power supply 11 according to a predetermined condition. For example, the power supply protection circuit may block the electric path to the power supply 11 when the voltage level of the power supply 11 is equal to or higher than a first voltage corresponding to overcharge. For example, the power supply protection circuit may block the electric path to the power supply 11 when the voltage level of the power supply 11 is lower than a second voltage corresponding to overdischarge.

The heater 18 may receive power from the power supply 11 to heat the medium or the aerosol-generating substance in the stick S. Although not shown in FIG. 14, the aerosol-generating device 1 may further include a power conversion circuit (e.g., DC-to-DC converter) configured to convert the power of the power supply 11 and supply the converted power to the cartridge heater 24 and/or the heater 18. In addition, if the aerosol-generating device 1 generates an aerosol in an induction heating way, the aerosol-generating device 1 may further include a DC-to-AC converter configured to convert direct current power of the power supply 11 into alternating current power.

The controller 12, the sensor 13, the output unit 14, the input unit 15, the communication unit 16, and the memory 17 may perform functions using power received from the power supply 11. Although not shown in FIG. 14, the aerosol-generating device may further include a power conversion circuit configured to convert the power of the power supply 11 and supply the converted power to the respective components, for example, a low dropout (LDO) circuit or a voltage regulator circuit. In addition, although not shown in FIG. 14, a noise filter may be provided between the power supply 11 and the heater 18. The noise filter may be a low-pass filter. The low-pass filter may include at least one inductor and a capacitor. The cutoff frequency of the low-pass filter may correspond to the frequency of a high-frequency switching current applied from the power supply 11 to the heater 18. The low-pass filter may prevent high-frequency noise components from being applied to the sensor 13, for example, the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome. However, the disclosure is not limited thereto. In addition, the heater 18 may be implemented as a metal wire, a metal plate on which an electrically conductive track is disposed, or a ceramic heating element. However, the disclosure is not limited thereto.

In another embodiment, the heater 18 may be an induction heater. For example, the heater 18 may include a susceptor configured to generate heat through a magnetic field applied by a coil, thereby heating the aerosol-generating substance.

The input unit 15 may receive information input from the user or may output information to the user. For example, the input unit 15 may be a touch panel. The touch panel may include at least one touch sensor configured to detect touch. For example, the touch sensor may include a capacitive touch sensor, a resistive touch sensor, a surface acoustic wave touch sensor, an infrared touch sensor, etc. However, the disclosure is not limited thereto.

The display 141 and the touch panel may be implemented as an integrated panel. For example, the touch panel may be inserted into the display 141 (on-cell type touch panel or in-cell type touch panel). For example, the touch panel may be added onto the display 141 (add-on type touch panel).

Meanwhile, the input unit 15 may include a button, a keypad, a dome switch, a jog wheel, a jog switch, etc. However, the disclosure is not limited thereto.

The memory 17 may be hardware storing various pieces of data processed in the aerosol-generating device 1. The memory 17 may store data processed and to be processed by the controller 12. The memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. The memory 17 may store data on an operation time of the aerosol-generating device 1, the maximum number of puffs, the current number of puffs, at least one temperature profile, and the user's smoking pattern.

The communication unit 16 may include at least one component for communication with other electronic devices. For example, the communication unit 16 may include at least one of a short-range communication unit or a wireless communication unit.

The short-range communication unit may include a Bluetooth communication unit, a Bluetooth low energy (BLE) communication unit, a near-field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, etc. However, the disclosure is not limited thereto.

The wireless communication unit may include a cellular network communication unit, an Internet communication unit, a computer network (e.g., LAN or WAN) communication unit, etc. However, the disclosure is not limited thereto.

Although not shown in FIG. 14, the aerosol-generating device 1 may further include a connection interface such as a universal serial bus (USB) interface, and may be connected to other external devices through the connection interface such as a USB interface to transmit and receive information or charge the power supply 11.

The controller 12 may control overall operation of the aerosol-generating device 1. In an embodiment, the controller 1 may include at least one processor. The processor may be implemented as an array of a plurality of logic gates or may be implemented as a combination of a general-purpose microprocessor and a memory in which a program executable in the microprocessor is stored. Also, it will be understood by those skilled in the art that the processor can be implemented in other forms of hardware.

The controller 12 may control the supply of power from the power supply 11 to the heater 18 to control the temperature of the heater 18. The controller 12 may control the temperature of the cartridge heater 24 and/or the heater 18 based on the temperature of the cartridge heater 24 and/or the heater 18 detected by the temperature sensor 131. The controller 12 may control the power supplied to the cartridge heater 24 and/or the heater 18 based on the temperature of the cartridge heater 24 and/or the heater 18. For example, the controller 12 may determine a target temperature of the cartridge heater 24 and/or the heater 18 based on the temperature profile stored in the memory 17.

The aerosol-generating device 1 may include a power supply circuit (not shown) electrically connected to the power supply 11 between the power supply 11 and the cartridge heater 24 and/or the heater 18. The power supply circuit may be electrically connected to the cartridge heater 24, the heater 18, or the induction coil 181. The power supply circuit may include at least one switching element. The switching element may be implemented as a bipolar junction transistor (BJT), a field effect transistor (FET), or the like. The controller 12 may control the power supply circuit.

The controller 12 may control switching of the switching element of the power supply circuit to control the supply of power. The power supply circuit may be an inverter configured to convert direct current power output from the power supply 11 into alternating current power. For example, the inverter may be composed of a full-bridge circuit or a half-bridge circuit including a plurality of switching elements.

The controller 12 may turn on the switching element so that power is supplied from the power supply 11 to the cartridge heater 24 and/or the heater 18. The controller 12 may turn off the switching element so that the supply of power to the cartridge heater 24 and/or the heater 18 is interrupted. The controller 12 may control the frequency and/or the duty ratio of the current pulse input to the switching element to control the current supplied from the power supply 11.

The controller 12 may control switching of the switching element of the power supply circuit to control the voltage output from the power supply 11. The power conversion circuit may convert the voltage output from the power supply 11. For example, the power conversion circuit may include a buck-converter configured to step down the voltage output from the power supply 11. For example, the power conversion circuit may be implemented as a buck-boost converter, a Zener diode, or the like.

The controller 12 may control on/off operation of the switching element included in the power conversion circuit to control the level of the voltage output from the power conversion circuit. If the switching element is maintained in an on state, the level of the voltage output from the power conversion circuit may correspond to the level of the voltage output from the power supply 11. The duty ratio for the on/off operation of the switching element may correspond to a ratio of the voltage output from the power conversion circuit to the voltage output from the power supply 11. As the duty ratio for the on/off operation of the switching element decreases, the level of the voltage output from the power conversion circuit may decrease. The heater 18 may be heated based on the voltage output from the power conversion circuit.

The controller 12 may control the supply of power to the heater 18 using at least one of a pulse width modulation (PWM) scheme or a proportional-integral-differential (PID) scheme.

For example, the controller 12 may perform control using the PWM scheme such that a current pulse having a predetermined frequency and a predetermined duty ratio is supplied to the heater 18. The controller 12 may control the frequency and the duty ratio of the current pulse to control the power supplied to the heater 18.

For example, the controller 12 may determine, based on the temperature profile, a target temperature to be controlled. The controller 12 may control the power supplied to the heater 18 using the PID scheme, which is a feedback control scheme using a difference value between the temperature of the heater 18 and the target temperature, a value obtained by integrating the difference value with respect to time, and a value obtained by differentiating the difference value with respect to time.

The controller 12 may prevent the cartridge heater 24 and/or the heater 18 from overheating. For example, the controller 12 may control operation of the power conversion circuit such that the supply of power to the cartridge heater 24 and/or the heater 18 is interrupted when the temperature of the cartridge heater 24 and/or the heater 18 exceeds a predetermined limit temperature. For example, the controller 12 may reduce the amount of power supplied to the cartridge heater 24 and/or the heater 18 by a predetermined ratio when the temperature of the cartridge heater 24 and/or the heater 18 exceeds a predetermined limit temperature. For example, when the temperature of the cartridge heater 24 exceeds a limit temperature, the controller 12 may determine that the aerosol-generating substance contained in the cartridge 19 has been exhausted and may interrupt the supply of power to the cartridge heater 24.

The controller 12 may control charging/discharging of the power supply 11. The controller 12 may check the temperature of the power supply 11 based on an output signal from the temperature sensor 131.

If a power line is connected to a battery terminal of the aerosol-generating device 1, the controller 12 may determine whether the temperature of the power supply 11 is equal to or higher than a first limit temperature, which is a reference temperature at which charging of the power supply 11 is interrupted. When the temperature of the power supply 11 is lower than the first limit temperature, the controller 12 may perform control such that the power supply 11 is charged based on a predetermined charging current. When the temperature of the power supply 11 is equal to or higher than the first limit temperature, the controller 12 may interrupt charging of the power supply 11.

When the aerosol-generating device 1 is in an on state, the controller 12 may determine whether the temperature of the power supply 11 is equal to or higher than a second limit temperature, which is a reference temperature at which discharging of the power supply 11 is interrupted. When the temperature of the power supply 11 is lower than the second limit temperature, the controller 12 may perform control such that the power stored in the power supply 11 is used. When the temperature of the power supply 11 is equal to or higher than the second limit temperature, the controller 12 may interrupt use of the power stored in the power supply 11.

The controller 12 may calculate or determine the remaining amount of power stored in the power supply 11. For example, the controller 12 may calculate or determine the remaining capacity of the power supply 11 based on a voltage and/or current detection value of the power supply 11.

The controller 12 may determine whether the stick S is inserted into the insertion space using the insertion detection sensor 133. The controller 12 may determine that the stick S has been inserted based on an output signal from the insertion detection sensor 133. Upon determining that the stick S has been inserted into the insertion space, the controller 12 may perform control such that power is supplied to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space using the insertion detection sensor 133. For example, the controller 12 may determine that the stick S has been removed from the insertion space when the temperature of the heater 18 is equal to or higher than a limit temperature or when the temperature change slope of the heater 18 is equal to or greater than a predetermined slope. Upon determining that the stick S has been removed from the insertion space, the controller 12 may interrupt the supply of power to the cartridge heater 24 and/or the heater 18.

The controller 12 may control a power supply time and/or the amount of power supplied to the heater 18 depending on the state of the stick S detected by the sensor 13. The controller 12 may check, based on a look-up table, a level range within which the level of a signal from the capacitance sensor is included. The controller 12 may determine the amount of moisture in the stick S based on the checked level range.

When the stick S is in a highly humid state, the controller 12 may control a time during which power is supplied to the heater 18 to increase a preheating time of the stick S compared to when the stick S is in a normal state.

The controller 12 may determine whether the stick S inserted into the insertion space is a reused stick using the reuse detection sensor 134. For example, the controller 12 may compare a sensing value of a signal from the reuse detection sensor with a first reference range within which the first color is included, and may determine that the stick S is not a reused stick when the sensing value is within the first reference range. For example, the controller 12 may compare a sensing value of a signal from the reuse detection sensor with a second reference range within which the second color is included, and may determine that the stick S is a reused stick when the sensing value is within the second reference range. Upon determining that the stick S is a reused stick, the controller 12 may interrupt the supply of power to the cartridge heater 24 and/or the heater 18.

The controller 12 may determine whether the aerosol-generating substance in the cartridge 19 is exhausted. For example, the controller 12 may apply power to preheat the cartridge heater 24 and/or the heater 18, and may determine whether the temperature of the cartridge heater 24 exceeds a limit temperature in a preheating section. When the temperature of the cartridge heater 24 exceeds the limit temperature, the controller 12 may determine that the aerosol-generating substance in the cartridge 19 has been exhausted. Upon determining that the aerosol-generating substance in the cartridge 19 has been exhausted, the controller 12 may interrupt the supply of power to the cartridge heater 24 and/or the heater 18.

The controller 12 may make a determination as to a user puff using the puff sensor 132. For example, the controller 12 may determine, based on a sensing value of a signal from the puff sensor, whether a puff occurs. For example, the controller 12 may determine the intensity of a puff based on a sensing value of a signal from the puff sensor 132. When the number of puffs reaches a predetermined maximum number of puffs or when no puff is detected for a predetermined time period or longer, the controller 12 may interrupt the supply of power to the cartridge heater 24 and/or the heater 18.

The controller 12 may control the output unit 14 based on a result of detection by the sensor 13. For example, when the number of puffs counted through the puff sensor 132 reaches a predetermined number, the controller 12 may notify the user that operation of the aerosol-generating device 1 will end soon through at least one of the display 141, the haptic unit 142, or the sound output unit 143. For example, upon determining that the stick S is not present in the insertion space, the controller 12 may notify the user of the determination result through the output unit 14. For example, upon determining that the cartridge 19 and/or the upper case has not been mounted, the controller 12 may notify the user of the determination result through the output unit 14. For example, the controller 12 may transmit information about the temperature of the cartridge heater 24 and/or the heater 18 to the user through the output unit 14.

Upon determining that a predetermined event has occurred, the controller 12 may store a history of the corresponding event in the memory 17 and may update the history. The event may include events performed in the aerosol-generating device 1, such as detection of insertion of the stick S, commencement of heating of the stick S, detection of puff, termination of puff, detection of overheating of the cartridge heater 24 and/or the heater 18, detection of application of overvoltage to the cartridge heater 24 and/or the heater 18, termination of heating of the stick S, on/off operation of the aerosol-generating device 1, commencement of charging of the power supply 11, detection of overcharging of the power supply 11, and termination of charging of the power supply 11. The history of the event may include the occurrence date and time of the event and log data corresponding to the event. For example, when the predetermined event is detection of insertion of the stick S, the log data corresponding to the event may include data on a value detected by the insertion detection sensor 133. For example, when the predetermined event is detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, and the current flowing through the cartridge heater 24 and/or the heater 18.

The controller 12 may perform control for formation of a communication link with an external device such as a user's mobile terminal. Upon receiving data on authentication from an external device via the communication link, the controller 12 may release restriction on use of at least one function of the aerosol-generating device 1. Here, the data on authentication may include data indicating completion of user authentication for the user corresponding to the external device. The user may perform user authentication through the external device. The external device may determine, based on the user's birthday or an identification number indicating the user, whether the user data is valid, and may receive data on the authority for use of the aerosol-generating device 1 from an external server. The external device may transmit data indicating completion of user authentication to the aerosol-generating device 1 based on the data on the use authority. When the user authentication is completed, the controller 12 may release restriction on use of at least one function of the aerosol-generating device 1. For example, when the user authentication is completed, the controller 12 may release restriction on use of a heating function for supplying power to the heater 18.

The controller 12 may transmit data on the state of the aerosol-generating device 1 to the external device through the communication link established with the external device. Based on the received state data, the external device may output the remaining capacity of the power supply 11 or the operation mode of the aerosol-generating device 1 through a display of the external device.

The external device may transmit a location search request to the aerosol-generating device 1 based on an input for commencement of search for the location of the aerosol-generating device 1. Upon receiving the location search request from the external device, the controller 12 may perform control, based on the received location search request, such that at least one of the output devices performs operation corresponding to location search. For example, the haptic unit 142 may generate vibration in response to the location search request. For example, the display 141 may output objects corresponding to location search and termination of search in response to the location search request.

Upon receiving firmware data from the external device, the controller 12 may perform control such that the firmware is updated. The external device may check the current version of the firmware of the aerosol-generating device 1 and may determine whether there is a new version of firmware. Upon receiving an input requesting firmware download, the external device may receive new version of firmware data and may transmit the new version of firmware data to the aerosol-generating device 1. Upon receiving the new version of firmware data, the controller 12 may perform control such that the firmware of the aerosol-generating device 1 is updated.

The controller 12 may transmit data on a value detected by the at least one sensor 13 to an external server (not shown) through the communication unit 16, and may receive, from the server, and store a learning model generated by learning the detected value through machine learning such as deep learning. The controller 12 may perform operation of determining the user's puff pattern and operation of generating the temperature profile using the learning model received from the server. The controller 12 may store data on the value detected by the at least one sensor 13 and data for training an artificial neural network (ANN) in the memory 17. For example, the memory 17 may store a database for each of the components provided in the aerosol-generating device 1 and weights and biases constituting the structure of the artificial neural network (ANN) in order to train the artificial neural network (ANN). The controller 12 may learn data on the value detected by the at least one sensor 13, the user's puff pattern, and the temperature profile, which are stored in the memory 17, and may generate at least one learning model used to determine the user's puff pattern and to generate the temperature profile.

As described above, according to at least one of the embodiments of the present disclosure, because the temperature coefficient of resistance of the lead of the resistance heater is much less than that of the electrically conductive track, the temperature of the heater may be accurately determined based on the resistance value of the heater.

According to at least one of the embodiments of the present disclosure, because the resistance value of the lead of the resistance heater is much less than that of the electrically conductive track, the amount of heat generated from the lead may be reduced, and heating efficiency of the heater may be increased.

According to at least one of the embodiments of the present disclosure, because the resistance value of the lead of the resistance heater is much less than that of the electrically conductive track, it may be possible to prevent parts other than the heater in the device from being heated.

According to at least one of the embodiments of the present disclosure, because the heat-generating track disposed at the outermost position among the heat-generating tracks of the electrically conductive track is long and wide, deviation between the heating temperatures of the parts of the hollow heater may be reduced, and the stick inserted into the heater may be evenly heated.

Referring to FIGS. 1 to 14, an aerosol-generating device 1 in accordance with one aspect of the present disclosure may include a body 10, a hollow heater 18 disposed in the body 10, providing an insertion space 43 with one side open, and providing therein an electrically conductive track 60, a circuit board 200 disposed in the body 10, and a lead 70 disposed at an end of the heater 18 and connected to the electrically conductive track 60 and the circuit board 200. A temperature coefficient of resistance of the lead 70 is 6 to 10 ppm/° C.

In addition, in accordance with another aspect of the present disclosure, the lead 70 may include an alloy containing nickel and copper, and the alloy may contain nickel and copper in a ratio of 40:60 to 50:50 by weight.

In addition, in accordance with another aspect of the present disclosure, the lead 70 may include constantan.

In addition, in accordance with another aspect of the present disclosure, the electrically conductive track 60 may generate heat to a temperature of 270° C. or lower.

In addition, in accordance with another aspect of the present disclosure, a resistance value of the electrically conductive track 60 may be 0.9 to 1.4 ohms at the temperature of 270° C. or lower.

In addition, in accordance with another aspect of the present disclosure, a resistance value of the lead 70 may be 0.008 to 0.012 ohms at the temperature of 270° C. or lower.

In addition, in accordance with another aspect of the present disclosure, the ratio of the resistance value between the electrically conductive track 60 and the lead 70 may be 90:1 to 110:1 at the temperature of 270° C. or lower.

In addition, in accordance with another aspect of the present disclosure, the ratio of the temperature coefficient of resistance between the electrically conductive track 60 and the lead 70 may be 100:1 to 500:1.

In addition, in accordance with another aspect of the present disclosure, the lead 70 may have a flat plate shape.

In addition, in accordance with another aspect of the present disclosure, the electrically conductive track 60 may include at least one heat-generating track 61a, 61b, and 61c, and a length of the at least one heat-generating track 61a, 61b, and 61c may be greater than a length of the lead 70 and a width of the at least one heat-generating track may be smaller than a width of the lead 70.

In addition, in accordance with another aspect of the present disclosure, a length of the at least one heat-generating track 61a, 61b, and 61c may be 90 mm to 110 mm and a width of the at least one heat-generating track 61a, 61b, and 61c may be 0.5 mm to 0.9 mm.

In addition, in accordance with another aspect of the present disclosure, a length of the lead 70 may be 4 mm to 5 mm and a width of the lead 70 may be 0.7 mm to 0.9 mm.

In addition, in accordance with another aspect of the present disclosure, the at least one heat-generating track 61a, 61b, and 61c may include a first track 61a disposed at the outermost portion of the electrically conductive track 60, a second track 61b disposed inside the first track 61a and including at least one bent portion, and a third track 61c disposed inside the second track 61b and including at least one bent portion. A width Wb of the second track 61b may be greater than or equal to the width Wa of the first track 61a and less than or equal to the width Wc of the third track 61c.

In addition, in accordance with another aspect of the present disclosure, the second track 61b may be spaced apart from the first track 61a or the third track 61c by an interval G2 less than one of the width Wa of the first track 61a, the width Wb of the second track 61b, and the width Wc of the third track 61c.

In addition, in accordance with another aspect of the present disclosure, the electrically conductive track 60 may include a connection portion 62 including a first connection portion 62a connected to one end of each of the first to third tracks 61a, 61b, and 61c and a second connection portion 62b connected to the other end of each of the first to third tracks 61a, 61b, and 61c, and the lead 70 may connect the connection portion 62 to the circuit board 200.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The above detailed description should not be construed as restrictive in all respects but should be considered as illustrative. The scope of the present disclosure should be determined by reasonable interpretation of the appended claims, and all changes within the equivalent scope of the present disclosure are embraced within the scope of the present disclosure.

What is claimed is:

1. An aerosol-generating device comprising:
a body;
a hollow heater disposed in the body, the heater providing an insertion space with one side open, the heater being providing therein an electrically conductive track;
a circuit board disposed in the body; and
a lead disposed at an end of the heater and connected to the electrically conductive track and the circuit board,
wherein a temperature coefficient of resistance of the lead is 6 to 10 ppm/° C.

2. The aerosol-generating device according to claim 1, wherein the lead comprises an alloy containing nickel and copper, and
wherein the alloy contains nickel and copper in a ratio of 40:60 to 50:50 by weight.

3. The aerosol-generating device according to claim 1, wherein the lead comprises constantan.

4. The aerosol-generating device according to claim 1, wherein the electrically conductive track generates heat to a temperature of 270° C. or lower.

5. The aerosol-generating device according to claim 4, wherein a resistance value of the electrically conductive track is 0.9 to 1.4 ohms at the temperature of 270° C. or lower.

6. The aerosol-generating device according to claim 4, wherein a resistance value of the lead is 0.008 to 0.012 ohms at the temperature of 270° C. or lower.

7. The aerosol-generating device according to claim 4, wherein the ratio of the resistance value between the electrically conductive track and the lead is 90:1 to 110:1 at the temperature of 270° C. or lower.

8. The aerosol-generating device according to claim 4, wherein the ratio of the temperature coefficient of resistance between the electrically conductive track and the lead is 100:1 to 500:1.

9. The aerosol-generating device according to claim 1, wherein the lead has a flat plate shape.

10. The aerosol-generating device according to claim 1, wherein the electrically conductive track comprises at least one heat-generating track, and
wherein a length of the at least one heat-generating track is greater than a length of the lead and
wherein a width of the at least one heat-generating track is smaller than a width of the lead.

11. The aerosol-generating device according to claim 10, wherein a length of the at least one heat-generating track is 90 mm to 110 mm and a width of the at least one heat-generating track is 0.5 mm to 0.9 mm.

12. The aerosol-generating device according to claim 10, wherein a length of the lead is 4 mm to 5 mm and a width of the lead is 0.7 mm to 0.9 mm.

13. The aerosol-generating device according to claim 10, wherein the at least one heat-generating track comprises:
a first track disposed at an outermost portion of the electrically conductive track;
a second track disposed inside the first track, the second track comprising at least one bent portion; and
a third track disposed inside the second track, the third track comprising at least one bent portion, and
wherein a width of the second track is greater than or equal to a width of the first track and less than or equal to a width of the third track.

14. The aerosol-generating device according to claim 13, wherein the second track is spaced apart from the first track or the third track by an interval less than one of the width of the first track, the width of the second track, and the width of the third track.

15. The aerosol-generating device according to claim 13, wherein the electrically conductive track comprises a connection portion comprising a first connection portion connected to one end of each of the first to third tracks and a second connection portion connected to another end of each of the first to third tracks, and
wherein the lead connects the connection portion to the circuit board.
